(19) United States
(12) Patent Application Publication
(10) Pub. No.: US 2026/0249776 A1
(43) Pub. Date: Aug. 27, 2026

(54) SNAP-ON ACCESSORY MOUNT FOR TRAILER RUB RAILS

(71) Applicant: Hyundai Translead, San Diego, CA (US)

(72) Inventors: Laura A. Homec, San Diego, CA (US); Weilun Chang, San Diego, CA (US); Alvaro J. Frausto, San Diego, CA (US)

(21) Appl. No.: 19/549,576

(22) Filed: Feb. 25, 2026

Related U.S. Application Data
(60) Provisional application No. 63/763,561, filed on Feb. 26, 2025.

(51) Int. Cl. B60P 7/08; F16B 2/24

(52) U.S. Cl. CPC B60P 7/0876; F16B 2/24

(57) ABSTRACT

Systems and devices for mounting an accessory on a rub rail of a trailer are provided. In one aspect, the system includes an accessory comprising a plurality of grooves and one or more snap-on accessory mounts including a body portion, an upper tension arm and a lower tension arm extending from a first side of the body portion, the upper tension arm and the lower tension arm configured to couple to the rub rail of the trailer, and a plurality of prongs, each of the plurality of prongs configured to engage one of the plurality of grooves of the accessory.

### INCORPORATION BY REFERENCE TO ANY PRIORITY APPLICATIONS

This application claims the benefit of priority to U.S. Provisional Patent Application No. 63/763,561, entitled “SNAP-ON ACCESSORY MOUNT FOR TRAILER RUB RAILS,” filed on Feb. 26, 2025, which is hereby incorporated by reference in its entirety and for all purposes.

### BACKGROUND

### Field

The present technology relates to a snap-on accessory mount for trailer rub rails and methods of using the snap-on accessory mount.

### Description of the Related Art

Rolling tarp wheel tracks (also known as roller tracks) can be mounted to the rub rails of flatbed trailers. These rolling tarp wheel tracks can connect rolling tarp accessories to the flatbed trailer. To install the rolling tarp wheel track on conventional trailers, the rolling tarp wheel track is lifted into position by multiple people and/or a pair of cranes and requires precise locating along the length of the trailer. The conventional rolling tarp wheel track is fastened to the rub rail with a number of fasteners positioned along the length of the trailer. The conventional method of installing a rolling tarp wheel track to a rub rail can be time consuming and prone to measuring errors and misalignment.

Therefore, a need exists for systems and methods of installing rolling tarp wheel tracks which can be quickly and accurately aligned to the rub rail of a trailer.

### SUMMARY

For purposes of summarizing the present disclosure and its advantages, certain objects and advantages of the present disclosure are described herein. Not all such objects or advantages may be achieved in any particular embodiment of the present disclosure. Thus, for example, those skilled in the art will recognize that the present disclosure may be embodied or carried out in a manner that achieves or optimizes one advantage or group of advantages as taught herein without necessarily achieving other objects or advantages as may be taught or suggested herein.

In one aspect, snap-on accessory mount for trailer rub rails is provided. The snap-on accessory mount includes a body portion, an upper tension arm and a lower tension arm extending from a first side of the body portion, the upper tension arm and the lower tension arm configured to couple to a rub rail of a trailer, and a plurality of prongs configured to couple to an accessory.

In some embodiments, the upper tension arm and the lower tension arm are parallel.

In some embodiments, the upper tension arm includes a barbed arm configured to engage a top surface of the rub rail, and the lower tension arm includes a barbed arm configured to engage a bottom surface of the rub rail.

In some embodiments, the plurality of prongs extend from a second side of the body portion opposite the first side of the body portion.

In some embodiments, a length of the body portion is the same as a length of a linear section of an exterior perimeter of a stake pocket of the trailer rub rail.

In some embodiments, a length of the body portion is 70 mm.

In some embodiments, the body portion is configured to contact a portion of an external surface of the rub rail.

In some embodiments, the snap-on accessory mount includes aluminum.

In some embodiments, the snap-on accessory mount includes plastic.

In some embodiments, a prong of the plurality of prongs includes an arm configured to engage a groove of the accessory with a snap-fit engagement.

In some embodiments, a prong of the plurality of prongs includes a barbed arm configured to flex as the prong is received in a groove of the accessory.

In some embodiments, each of the plurality of prongs is configured to slidingly engage a groove of the accessory.

In some embodiments, the accessory includes a rolling tarp wheel track.

In one aspect, a system for mounting an accessory on a rub rail of a trailer is provided. The system including the accessory including a plurality of grooves, and a snap-on accessory mount. The snap-on access mount includes a body portion, and an upper tension arm and a lower tension arm extending from a first side of the body portion. The upper tension arm and the lower tension arm are configured to couple to the rub rail of the trailer. The snap-on accessory mount also includes a plurality of prongs, each of the plurality of prongs configured to engage one of the plurality of grooves of the accessory.

In some embodiments, a prong of the plurality of prongs includes an arm configured to engage one of the plurality of grooves of the accessory with a snap-fit engagement.

In some embodiments, a prong of the plurality of prongs includes a barbed arm configured to flex as the prong is received in one of the plurality of grooves of the accessory.

In some embodiments, each of the plurality of prongs is configured to slidingly engage one of the plurality of grooves of the accessory.

In some embodiments, the accessory includes a rolling tarp wheel track.

In some embodiments, the system further includes a second snap-on accessory mount. The second snap-on accessory mount includes a body portion, and an upper tension arm and a lower tension arm extending from a first side of the body portion. The upper tension arm and the lower tension arm are configured to couple to the rub rail of the trailer. The snap-on accessory mount also includes a plurality of prongs configured to engage the accessory.

In some embodiments, the snap-on accessory mount and the second snap-on accessory mount are configured to engage with the accessory at different locations along a length of the accessory.

In some embodiments, the rub rail is integral to a side rail of the trailer.

In some embodiments, the rub rail is welded to a side rail of the trailer.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1A illustrates a top view of an embodiment of a flatbed trailer according to the present disclosure.

FIG. 1B illustrates a side view of the flatbed trailer of FIG. 1A.

FIG. 2A illustrates a top view of a rub rail-side rail assembly of FIGS. 1A and 1B according to an embodiment of the present disclosure.

FIG. 2B illustrates a side view of the rub rail-side rail assembly of FIGS. 1A and 1B.

FIG. 3A illustrates a detailed view of the top view of the rub rail-side rail assembly illustrated in FIGS. 2A and 2B.

FIG. 3B illustrates a detailed view of the side view of the rub rail-side rail assembly illustrated in FIGS. 2A and 2B.

FIG. 4 illustrates a cross-sectional view of the rub rail - side rail assembly illustrated in FIG. 2B.

FIG. 5 illustrates a top view of snap-on clips implemented on the flatbed trailer illustrated in FIGS. 1A and 1B according to an embodiment of the present disclosure.

FIG. 6A illustrates a cross-sectional view of a system including a snap-on bracket and an accessory coupled to a rub rail according to an embodiment of the present disclosure.

FIG. 6B illustrates a schematic top side view of a snap-on bracket coupled to a rub rail according to an embodiment of the present disclosure.

FIG. 7 illustrates a cross-sectional view of the snap-on bracket illustrated in FIG. 6A coupled to the rub rail illustrated in FIG. 6A and an accessory according to another embodiment of the present disclosure.

FIG. 8 illustrates a cross-sectional view of a system including a snap-on bracket and a wheel track coupled to a rub rail according to another embodiment of the present disclosure.

FIG. 9 illustrates a cross-sectional view of a system including a snap-on bracket and a wheel track coupled to a rub rail according to another embodiment of the present disclosure.

FIG. 10 illustrates a cross-sectional view of a system including a snap-on bracket and a wheel track coupled to a rub rail according to another embodiment of the present disclosure.

FIG. 11 illustrates a cross-sectional view of a system including a snap-on bracket and a wheel track coupled to a rub rail according to another embodiment of the present disclosure.

FIG. 12 illustrates a cross-sectional view of a system including a wheel track coupled to a rub rail according to another embodiment of the present disclosure.

FIG. 13 illustrates a cross-sectional view of a system including a snap-on bracket and a wheel track coupled to a rub rail according to another embodiment of the present disclosure.

FIG. 14 illustrates a cross-sectional view of a system including a slide-on wheel track coupled to a rub rail according to another embodiment of the present disclosure.

FIG. 15 illustrates a cross-sectional view of a system including a slide-on wheel track coupled to a rub rail according to another embodiment of the present disclosure.

### DETAILED DESCRIPTION

A rolling tarp wheel track (also known as a roller track) is typically installed on a rub rail of a flatbed trailer to use rolling tarp accessories on the flatbed trailer. To install the rolling tarp wheel track, the rolling tarp wheel track is lifted into position by multiple people and/or a pair of cranes. The position of the rolling tarp wheel track relative to the rub rail is measured at multiple locations along the length of the rolling tarp wheel track, to ensure accurate horizontal and vertical alignment relative to the rub rail. The rolling tarp wheel track is then clamped to the rub rail using a vice. Next, holes are drilled through the rub rail and the rolling tarp wheel track, and fasteners such as bolts, rivets, or screws are used to attach the rolling tarp wheel track to the rub rail. This method of installing a rolling tarp wheel track to a rub rail can be time consuming and prone to measuring errors and misalignment, as it can be difficult to properly align the rolling tarp wheel track along its entire length relative to the rub rail.

Embodiments of the present disclosure provide snap-on accessory mounts for rub rails and methods of using the snap-on accessory mounts that overcome these and other drawbacks. The snap-on accessory mounts can include snap-on brackets or clips. The snap-on accessory mounts can be used to attach various types of accessories to a rub rail of a vehicle. For example, the snap-on accessory mounts can be used to attach an accessory rolling tarp wheel track to a flatbed trailer. Although embodiments of the present disclosure are described with reference to snap-on accessory mounts that can be used to attach accessories to rub rails, it will be understood that embodiments of the snap-on accessory mounts can be suitably implemented with other types of rails or structures. Embodiments of the present disclosure are also described with reference to snap-on accessory mounts that are configured to attach a rolling tarp wheel track to a vehicle, but it will be understood that embodiments of the snap-on accessory mounts can be suitably implemented with other types of accessories. Embodiments of the present disclosure are also described with reference to snap-on accessory mounts that are configured to attach an accessory to a flatbed trailer, but it will be understood that embodiments of the snap-on accessory mounts can be suitably implemented to attach an accessory to other types of vehicles.

Embodiments of snap-on accessory mounts according to the present disclosure can include a snap-on bracket or clip. The snap-on accessory mount can attach a rub rail to an accessory rolling tarp wheel track (hereinafter “an accessory”). The snap-on accessory mount can act as an intermediary between the accessory and the rub rail of a vehicle, such as a flatbed trailer. The accessory can be a rolling tarp wheel track. In one non-limiting example, the snap-on accessory mount is configured to couple to the rub rail of a flatbed trailer by snapping on to the rub rail. The snap-on accessory mount can snap lock on to the rub rail. The snap-on accessory mount can be configured to couple to the rub rail by engaging features of the rub rail with a sliding engagement. In another non-limiting example, the accessory may incorporate features configured to directly engage the rub rail. The accessory may be configured to couple to the rub rail by engaging features of the rub rail with a sliding engagement. For example, the accessory can be configured to engage the rub rail by sliding through one or more grooves or channels of the rub rail. For another example, the accessory may include one or more grooves or channels and be configured to engage the rub rail by engaging tongues or arms of the rub rail through one or more grooves or channels of the accessory.

An accessory can be configured to couple to the snap-on accessory mount in various ways. In one non-limiting example, an accessory such as a rolling tarp wheel track is configured to couple to the snap-on accessory mount by snapping on to the snap-on accessory mount. The rolling tarp wheel track can snap lock onto the snap-on accessory mount. In another non-limiting example, the rolling tarp wheel track is configured to couple to the snap-on accessory mount by sliding onto the snap-on accessory mount. For example, the snap-on accessory mount can be configured to engage the rolling tarp wheel track by sliding through one or more grooves or channels of the rolling tarp wheel track. In still another example of the present disclosure, a single structural feature of the rolling tarp wheel track is configured to couple to the snap-on accessory mount using two different alternative mechanisms: by snapping the structural feature onto the snap-on accessory mount or by receiving a prong or post of the snap-on accessory mount into the structural feature by sliding. For example, in these embodiments, the snap-on accessory mount can include structures (such as prongs or posts) that can be snapped onto or slid through corresponding structures (such as grooves or channels) of the rolling tarp wheel track. In yet another example of the present disclosure, the snap-on accessory mount includes a first structure (such as a prong or post) configured to couple to the rolling tarp wheel track using two different alternative mechanisms (such as a snap-on mechanism or a sliding mechanism) and a second structure (such as a hook or arm) configured to couple to the rolling tarp wheel track using one mechanism (such as a sliding mechanism).

The snap-on accessory mount can be an aluminum extrusion. The snap-on accessory mount can be formed from aluminum. The snap-on accessory mount can be formed from or include any other suitable material, for example but not limited to a plastic or a composite.

Advantageously, embodiments of snap-on accessory mounts according the present disclosure can reduce the time required to install a rolling tarp wheel track onto a vehicle, such as a flatbed trailer. The snap-on accessory mount can also advantageously improve the alignment of the rolling tarp wheel track relative to the flatbed trailer. The snap-on accessory mount can reduce or eliminate the need to measure alignment of the rolling tarp wheel track relative to the rub rail prior to installing the rolling tarp wheel track on to the flatbed trailer. The snap-on accessory mount can reduce and/or eliminate the need for tools while installing the rolling tarp wheel track on to the flatbed trailer. For example, the snap-on accessory mount can eliminate the need for welding, clamping, measuring, leveling, drilling, bolting, and/or riveting. Additionally, the snap-on accessory mount can advantageously reduce and/or eliminate any permanent structural change or damage to the rub rail because there are no holes drilled through the rub rail in embodiments of the present disclosure. Embodiments of the snap-on accessory mount can advantageously permit a rolling tarp wheel track to be decoupled or de-installed from a rub rail, without any permanent structural change or damage to the rub rail, in the event the rolling tarp is no longer in use or desired.

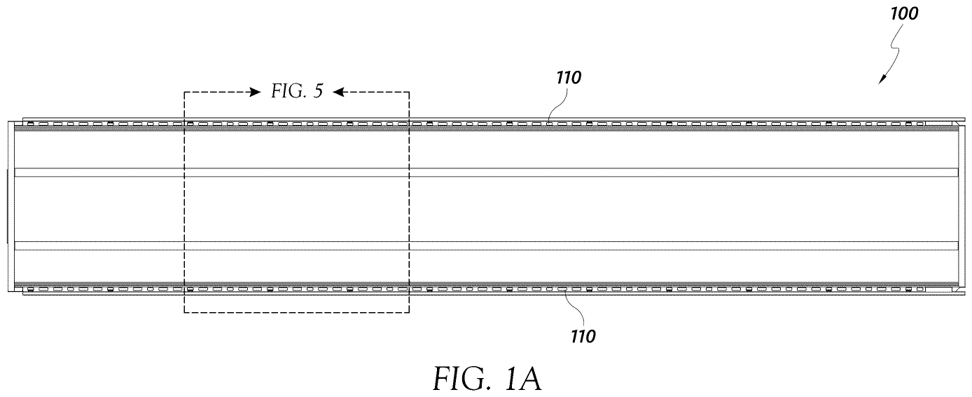

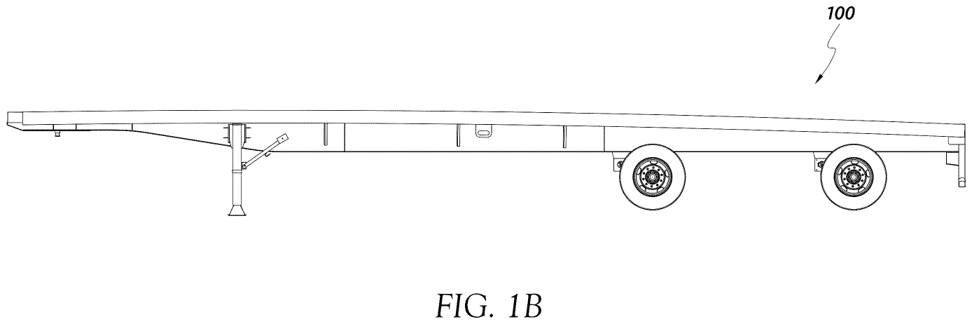

FIG. 1A illustrates a top view of an embodiment of a trailer 100 according to the present disclosure. The trailer 100 can be a flatbed trailer. FIG. 1B illustrates a side view of the trailer 100 of FIG. 1A. The trailer 100 includes a rub rail-side rail assembly 110 on each side of the trailer 100. One rub rail-side rail assembly 110 extends along a first side of the trailer 100 and a second rub rail-side rail assembly 110 extends along a second side of the trailer 100. Each rub rail-side rail assembly 110 extends along a length of the trailer 100.

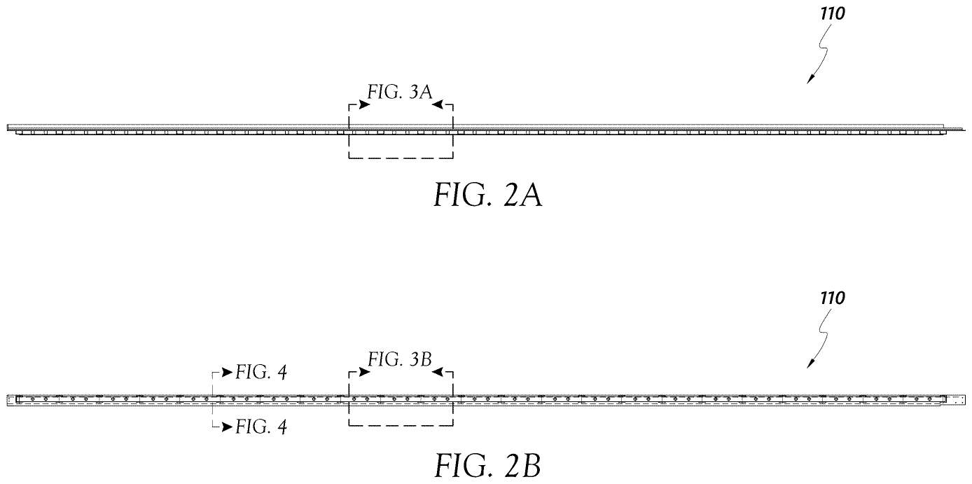

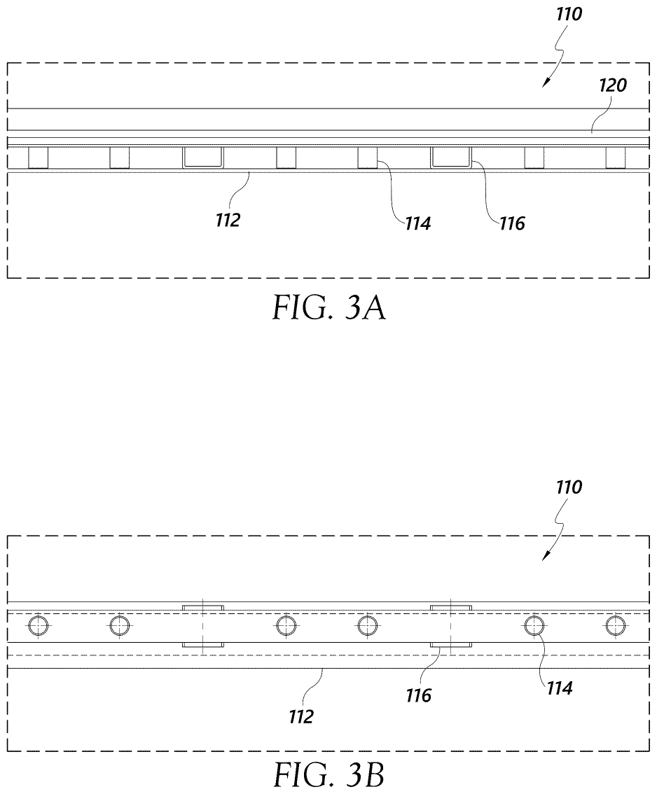

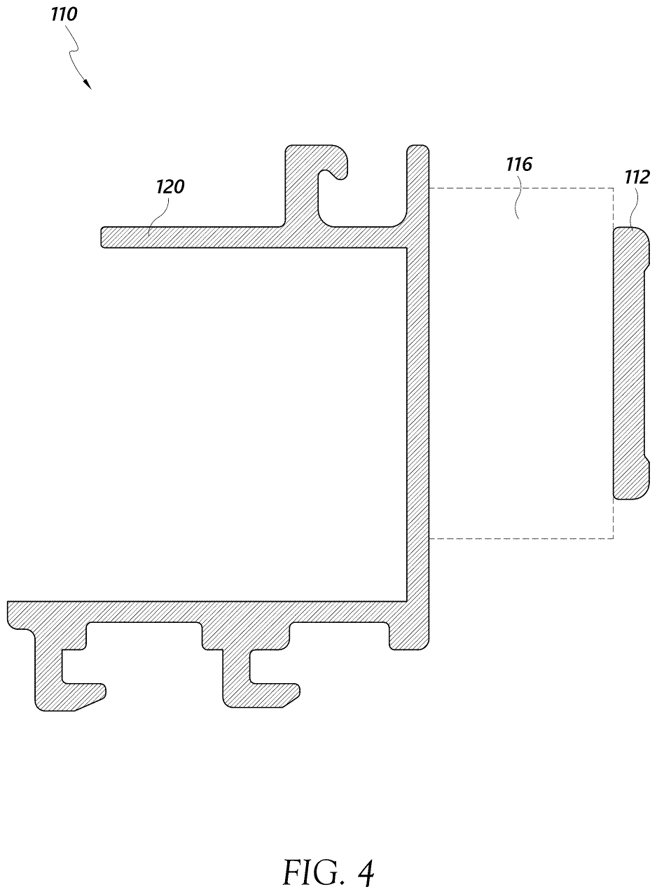

FIG. 2A illustrates a top view of the rub rail-side rail assembly 110 of FIGS. 1A and 1B according to an embodiment of the present disclosure. FIG. 2B illustrates a side view of the rub rail-side rail assembly 110 of FIGS. 1A and 1B. FIG. 3A illustrates a detailed view of the top view of the rub rail-side rail assembly 110 illustrated in FIGS. 2A and 2B. FIG. 3B illustrates a detailed view of the side view of the rub rail-side rail assembly 110 illustrated in FIGS. 2A and 2B. FIG. 4 illustrates a cross-sectional view of the rub rail-side rail assembly 110 shown in FIG. 2B.

The rub rail-side rail assembly 110 includes a rub rail 112 attached to a side rail 120. In some examples, the rub rail 112 and the side rail 120 are extruded to form an integral, monolithic assembly. In other examples, such as that illustrated in FIGS. 2A, 2B, 3A, 3B, and 4, the rub rail 112 and the side rail 120 are separate components that are coupled together, for example by welding. The rub rail 112 includes a plurality of stake pockets 116 positioned along a longitudinal axis of the rub rail 112 between a front section and a rear section of the rub rail 112. The rub rail 112 also includes a plurality of pipe spools 114 positioned along the longitudinal axis of the rub rail 112 between the front section and the rear section of the rub rail 112. The pipe spools 114 and the stake pockets 116 are interspersed along the longitudinal axis of the rub rail 112. A cross-section A-A of FIG. 2B is shown in FIG. 4, and is taken through a stake pocket 116. The cross-section A-A illustrates the side rail 120 and the rub rail 112, and the stake pocket 116 is shown as an opening between the side rail 120 and the rub rail 112.

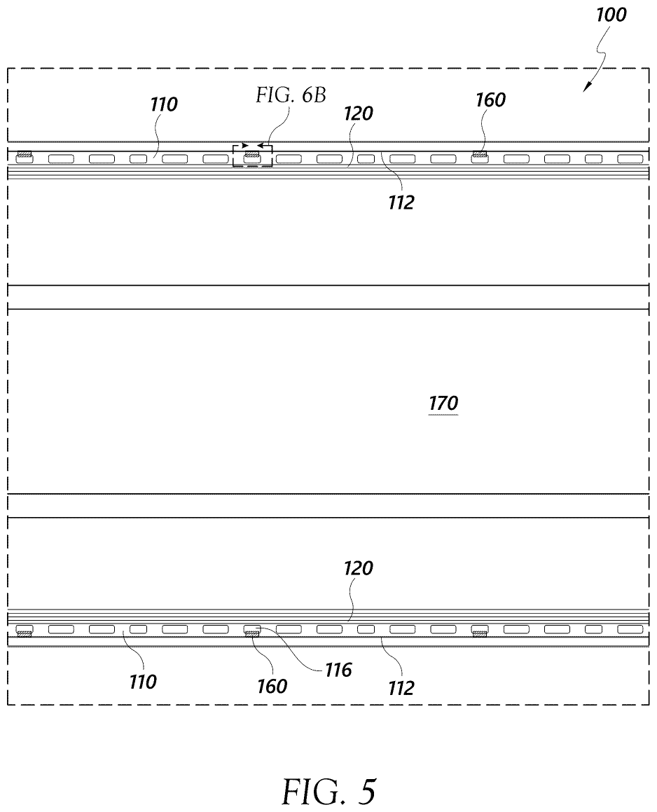

Embodiments of the present disclosure include snap-on accessory mounts configured to attach various types of accessories to a rub rail of a vehicle, such as the trailer 100. In non-limiting embodiments, the snap-on accessory mounts can be used to attach an accessory rolling tarp wheel track to a trailer 100. The snap-on accessory mounts can include snap-on brackets or clips. FIG. 5 illustrates a top view of snap-on clips 160 implemented on the trailer 100 illustrated in FIGS. 1A and 1B according to an embodiment of the present disclosure. The trailer 100 can include a rub rail-side rail assembly 110 on each of the right side and the left side of the trailer 100. The rub rail-side rail assembly 110 can include a side rail 120 coupled to a rub rail 112 that includes a plurality of stake pockets 116 along the longitudinal axis of the rub rail 112. Snap-on clips 160 can be coupled to the rub rails 112 by installing a snap-on clip 160 at each stake pocket 116 of each of the right side and left side rub rail-side rail assemblies 110. Alternatively, snap-on clips 160 can be coupled to the rub rails 112 by installing a snap-on clip 160 at every other stake pocket 116 of each of the right side and left side rub rail-side rail assemblies 110. Other configurations can be suitably implemented in accordance with the present disclosure. For example, snap-on clips 160 can be coupled to the rub rails 112 by installing a snap-on clip 160 at every third or fourth stake pocket 116 of each of the right side and left side rub rails-side rail assemblies 110. In some examples, the snap-on clips 160 can be positioned every 4 feet along the length of the trailer 100. In other examples, snap-on clips 160 can be installed at other suitable intervals. For example, the snap-on clips 160 can be positioned at every 2 feet or at every 8 feet along the length of the trailer 100.

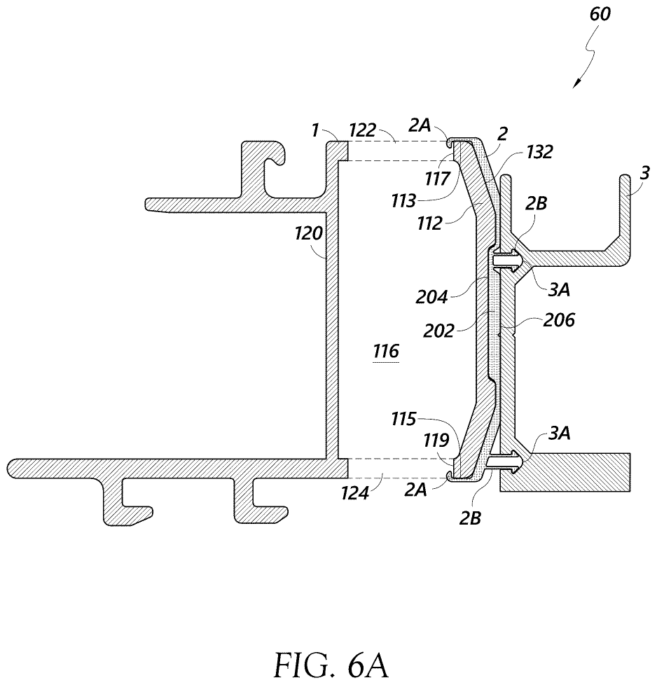

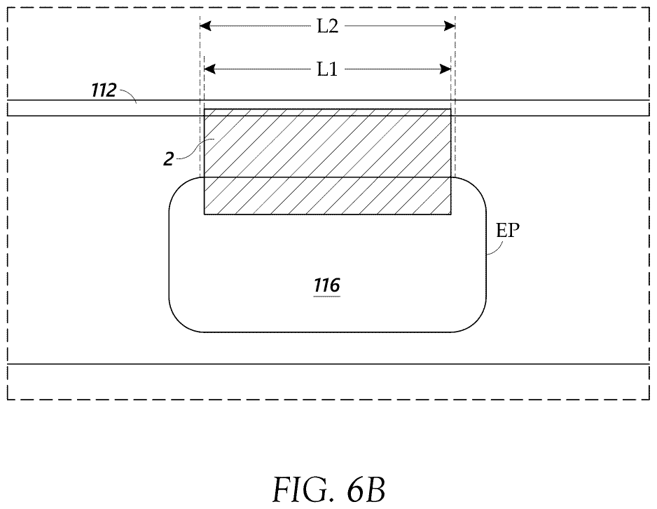

Embodiments of the present disclosure include a system including snap-on accessory mounts configured to attach various types of accessories, for example, rolling tarp wheel tracks, to a rub rail of a vehicle, such as the trailer 100. FIG. 6A illustrates a cross-sectional view of a system 60 including a snap-on accessory mount 2 and an accessory 3 coupled to a rub rail 112 according to an embodiment of the present disclosure. In this non-limiting example, the snap-on accessory mount 2 includes a snap-on bracket 2 or a snap-on clip 2. In this non-limiting example, the accessory 3 includes a wheel track 3. FIG. 6B illustrates a schematic top side view of a snap-on bracket 2 coupled to a rub rail 112 according to an embodiment of the present disclosure. The system 60 can include a rub rail-side rail assembly 1, the snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail 112 of the assembly 1 and can be configured to reversibly engage the accessory 3. The snap-on clip 2 can be configured to reversibly engage the rub rail 112 of the assembly 1 with a snap-fit engagement and can be configured to reversibly engage the accessory 3 via a snap-fit engagement. The snap-on clip 2 can be configured to reversibly engage a stake pocket 116 of the rub rail 112 with a snap-fit engagement. In this example, the accessory 3 includes a rolling tarp wheel track 3 configured to couple a rolling tarp to a trailer 100. The rub rail-side rail assembly 1 can be an extruded rub rail-side rail assembly 1, where the rub rail 112 and the side rail 120 are formed integrally as a monolithic structure.

The snap-on clip 2 can include an upper tension arm 2A and a lower tension arm 2A. The upper tension arm 2A and the lower tension arm 2A can each extend from a first side 204 of a body portion 202 of the snap-on clip 2. The upper tension arm 2A and the lower tension arm 2A can be parallel. The snap-on clip 2 can couple to the rub rail 112 of the assembly 1 using tension forces caused by elastic bending of the upper tension arm 2A and the lower tension arm 2A of the snap-on clip 2. The body portion 202 of the snap-on clip 2 can contact a portion of an external surface 132 of the rub rail 112. The upper tension arm 2A can include a barbed arm configured to engage a top surface 113 of the rub rail 112 and an interior surface 117 of the rub rail 112 that defines a top opening 122 of a stake pocket 116. The lower tension arm 2A can include a barbed arm configured to engage a bottom surface 115 of the rub rail 112 and an interior surface 119 of the rub rail 112 that defines a bottom opening 124 of a stake pocket 116. The upper tension arm 2A and the lower tension arm 2A can form a snap fit engagement with the rub rail 112 at the stake pocket 116.

As illustrated in FIG. 6B, in some non-limiting examples, a length L1 of the snap-on clip 2 is substantially the same as a length of a linear section L2 of an exterior perimeter EP of a stake pocket 116 of the rub rail 112. In one example embodiment illustrated in FIG. 6B, the length L1 of the snap-on clip 2 is about 70 mm (2.756 inches). The length L2 can be 0 mm, 0.1 mm, 0.2 mm, 0.5 mm, 1 mm, or 2 mm longer than the length L1. Advantageously, a snap-on clip 2 that is substantially the same length as the stake pocket 116 can be inhibited from moving lengthwise along the rub rail 112. In some examples, the snap-on clip 2 can include aluminum, a plastic, or a composite.

The snap-on clip 2 can include one or more prongs or posts 2B. The prongs 2B can extend from a second side 206 of the body portion 202 opposite from the first side 204. In the non-limiting example of FIG. 6A, the snap-on clip 2 includes a plurality of prongs or posts 2B. The plurality of prongs 2B can include an upper prong 2B and a lower prong 2B. The prongs 2B can include snap-fit barbs. The prong 2B can include barbed arms separated by a distance and configured to flex toward each other. The accessory 3 can include a plurality of grooves or channels 3A. The snap-on clip 2 can couple to the accessory 3. In this example, each of the prongs 2B of the snap-on clip 2 is configured to be received in a groove 3A of the accessory 3. Other types of engagement mechanisms can be suitably implemented in embodiments of the present disclosure. For example, the snap-on clip 2 can include a plurality of male tension snaps 2B configured to engage a plurality of female tension snaps 3A of the accessory 3.

The prongs 2B of the snap-on clip 2 can be configured to be received in the grooves 3A by a snapping engagement or a sliding engagement. For example, the barbed arms of the prong 2B can be configured to flex toward each other as the prong 2B is received in a groove 3A, and to flex away from each other after the prong 2B engages the groove 3A with a snap-fit engagement. In such examples, the accessory 3 may engage a plurality of snap-on clips 2 simultaneously as the accessory 3 is first aligned against the side of the trailer 100 and then pushed laterally into a snap-lock engagement with the snap-on clips 2. For example, the accessory 3 may engage a first snap-on clip 2 coupled to the rub rail 112 at a first stake pocket 116 at the same time or nearly the same time the accessory 3 engages a second, adjacent snap-on clip 2 coupled to the rub rail 112 at a second, adjacent stake pocket 116.

The prong 2B can also be configured to slide into the groove 3A, starting from a front side or a rear side of the trailer 100, thereby engaging the snap-on clip 2 to the accessory 3 with a sliding engagement. In such cases, the barbed arms of the prong 2B may not flex or may flex minimally as the accessory 3 slides onto the snap-on clip 2. In such examples, the accessory 3 may slidingly engage a plurality of snap-on clips 2 sequentially as the accessory 3 is slid along the trailer 100 from a front section toward a rear section of the trailer 100, or from the rear section toward the front section of the trailer 100. For example, the accessory 3 may first slidingly engage a first snap-on clip 2 coupled to the rub rail at a first stake pocket 116, and then slidingly engage a second, adjacent snap-on clip 2 coupled to the rub rail at a second, adjacent stake pocket 116.

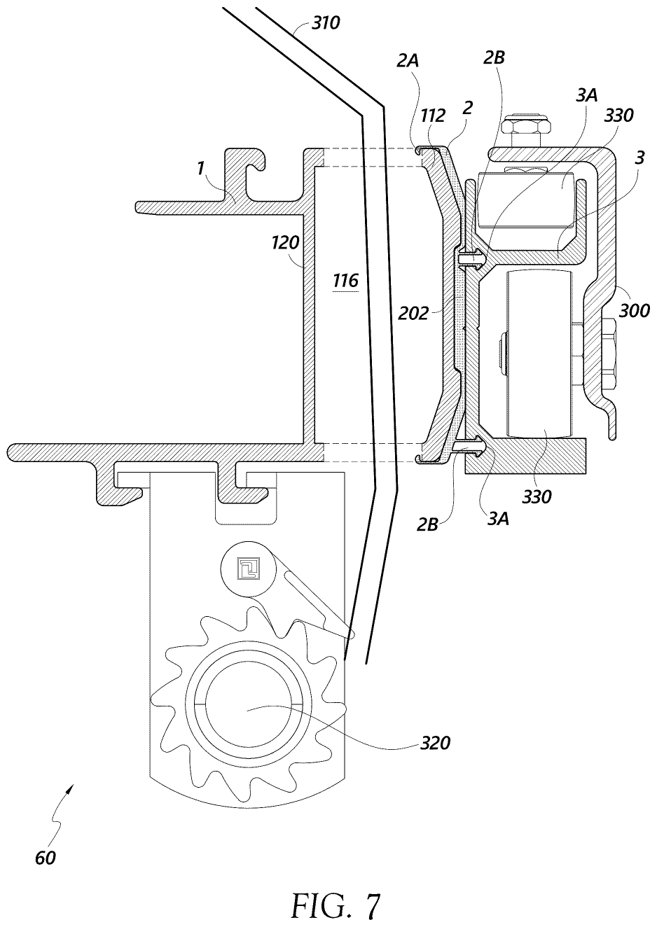

FIG. 7 illustrates a cross-sectional view of the snap-on bracket 2 illustrated in FIG. 6A coupled to the rub rail 112 illustrated in FIG. 6A and an accessory 3 according to another embodiment of the present disclosure. The snap-on clip 2 is engaged to the rub rail 112 of the assembly 1 at a stake pocket 116 (illustrated in cross-section between the side rail 120 and the rub rail 112). In this non-limiting embodiment, the snap-on clip 2 is engaged to the rub rail 112 of the assembly 1 at a stake pocket 116 via a snap-fit engagement. The rub rail-side rail assembly 1 can engage a winch 320, and a winch strap 310 can pass through the stake pocket 116 of the rub rail-side rail assembly 1. The accessory 3 can engage one or more tarp roller wheels 330 of a rolling tarp 300. In some examples, the snap-on clip 2 can include aluminum, plastic, or a composite.

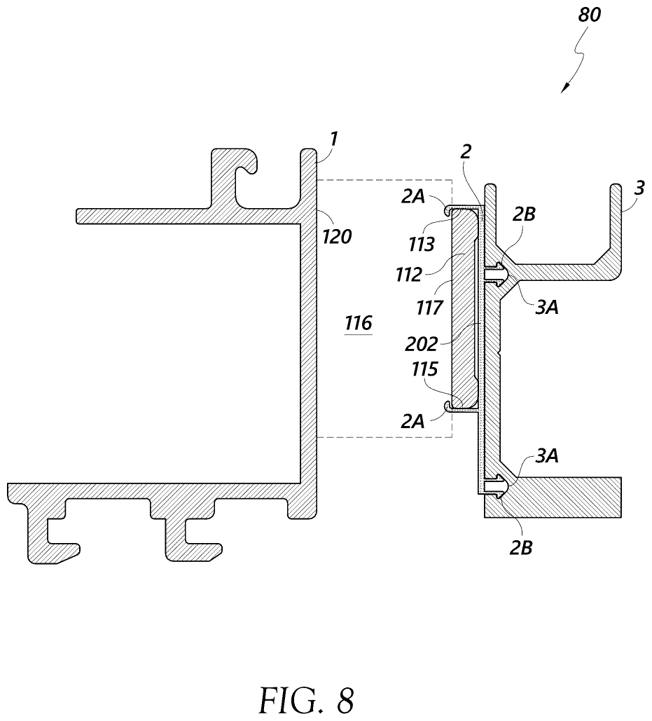

FIG. 8 illustrates a cross-sectional view of a system 80 including a snap-on bracket 2 and an accessory 3 coupled to a rub rail 112 according to another embodiment of the present disclosure. In this non-limiting example, the accessory 3 includes a wheel track 3. The system 80 can include a rub rail-side rail assembly 1, a snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail 112 of the assembly 1, and can be configured to reversibly engage the accessory 3. The snap-on clip 2 can be configured to reversibly engage the rub rail 112 of the assembly 1 via a snap-fit engagement, and can be configured to reversibly engage the accessory 3 via a snap-fit engagement. In this example, the accessory 3 includes a rolling tarp wheel track 3 configured to couple a rolling tarp to a trailer 100. The rub rail-side rail assembly 1 can be a welded rub rail-side rail assembly 1, where the side rail and the rub rail are separate components that are coupled together, for example by welding.

The snap-on clip 2 can include an upper tension arm 2A and a lower tension arm 2A. The upper tension arm 2A and the lower tension arm 2A can extend from a first side of a body portion 202 of the snap-on clip 2. The snap-on clip 2 can couple to the rub rail 112 of the assembly 1 using tension forces caused by elastic bending of the upper tension arm 2A and the lower tension arm 2A of the snap-on clip 2. The upper tension arm 2A can include a barbed arm configured to engage a top surface 113 of the rub rail 112 and an interior surface 117 of the rub rail that defines a top opening of a stake pocket 116. The lower tension arm 2A can include a barbed arm configured to engage a bottom surface 115 of the rub rail 112 and the interior surface 117 of the rub rail 112 that defines a bottom opening of a stake pocket 116. The upper tension arm 2A and the lower tension arm 2A can engage with the rub rail 112 at the stake pocket 116. The upper tension arm 2A and the lower tension arm 2A can form a snap fit engagement with the rub rail 112 at the stake pocket 116. In some non-limiting examples, a length of the accessory 3 is substantially the same as a length of a linear section L of an exterior perimeter EP of the stake pocket 116. See, for example, a linear section L of an exterior pocket EP of a stake pocket 116 described above with reference to FIG. 6B. In one example embodiment, the length of the snap-on clip 2 is about 70 mm (2.756 inches). Advantageously, a snap-on clip 2 that is substantially the same length as the stake pocket can be inhibited from moving lengthwise along the rub rail. In some examples, the snap-on clip 2 can include aluminum, a plastic, or a composite.

The snap-on clip 2 can include one or more prongs or posts 2B. The one or more prongs or posts 2B can extend from a second side of the body portion 202 of the snap-on clip 2. The prong 2B can include barbed arms separated by a distance and configured to flex toward each other. The accessory 3 can include a plurality of grooves or channels 3A. The snap-on clip 2 can couple to the accessory 3. In this example, each of the prongs 2B of the snap-on clip 2 is configured to be received in a groove 3A of the accessory 3. Other types of engagement mechanisms can be suitably implemented in embodiments of the present disclosure. For example, the snap-on clip 2 can include a plurality of male tension snaps 2A configured to engage a plurality of female tension snaps 3A of the accessory 3.

The prongs 2B of the snap-on clip 2 can be configured to be received in the grooves 3A by a snapping engagement or a sliding engagement. For example, the barbed arms of the prong 2B can be configured to flex toward each other as the prong 2B is received in a groove 3A, and to flex away from each other after the prong 2B engages the groove 3A with a snap-fit engagement. In such examples, the accessory 3 may engage a plurality of snap-on clips 2 simultaneously as the accessory 3 is first aligned against the side of the trailer 100 and then pushed laterally into a snap-lock engagement with the snap-on clips 2. For example, the accessory 3 may engage a first snap-on clip 2 coupled to the rub rail 112 at a first stake pocket 116 at the same time or nearly the same time the accessory 3 engages a second, adjacent snap-on clip 2 coupled to the rub rail 112 at a second, adjacent stake pocket 116.

The prong 2B can also be configured to slide into the groove 3A, starting from a front side or a rear side of the trailer 100, thereby engaging the snap-on clip 2 to the accessory 3 with a sliding engagement. In such cases, the barbed arms of the prong 2B may not flex or may flex minimally as the accessory 3 slides onto the snap-on clip 2. In such examples, the accessory 3 may slidingly engage a plurality of snap-on clips 2 sequentially as the accessory 3 is slid along the trailer 100 from a front section toward a rear section of the trailer 100, or from the rear section toward the front section of the trailer 100. For example, the accessory 3 may first slidingly engage a first snap-on clip 2 coupled to the rub rail 112 at a first stake pocket 116, and then slidingly engage a second, adjacent snap-on clip 2 coupled to the rub rail 112 at a second, adjacent stake pocket 116.

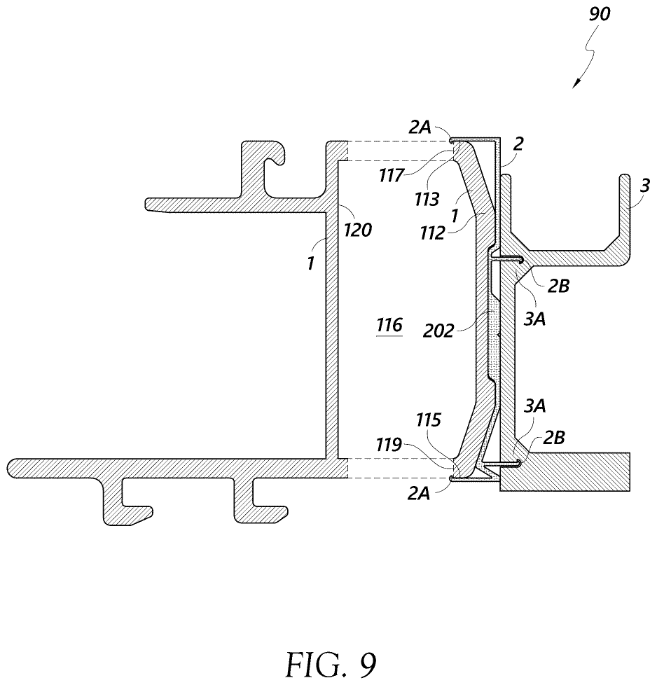

FIG. 9 illustrates a cross-sectional view of a system 90 including a snap-on bracket 2 and an accessory 3 coupled to a rub rail 112 according to another embodiment of the present disclosure. In this non-limiting example, the accessory 3 includes a wheel track 3. The system 90 can include a rub rail-side rail assembly 1, a snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail 112 of the assembly 1, and can be configured to reversibly engage the accessory 3. The snap-on clip 2 can be configured to reversibly engage the rub rail 112 of the assembly 1 via a snap-fit engagement, and can be configured to reversibly engage the accessory 3 via a snap-fit engagement. In this example, the accessory 3 includes a rolling tarp wheel track 3 configured to couple a rolling tarp to a trailer 100. The rub rail-side rail assembly 1 can be an extruded rub rail-side rail assembly 1, where the rub rail 112 and the side rail 120 are formed integrally as a monolithic structure.

The snap-on clip 2 can include an upper tension arm 2A and a lower tension arm 2A. The upper tension arm 2A and the lower tension arm 2A can extend from a first side of a body portion 202 of the snap-on clip 2. The snap-on clip 2 can couple to the rub rail 112 of the assembly 1 using tension forces caused by elastic bending of the upper tension arm 2A and the lower tension arm 2A of the snap-on clip 2. The upper tension arm 2A can include an arm terminating in a barb or bulb. The upper tension arm 2A can be configured to engage a top surface 113 of the rub rail 112 and an interior surface 117 of the rub rail 112 that defines a top opening of a stake pocket 116. The lower tension arm 2A can include an arm terminating in a barb or bulb. The lower tension arm 2A can be configured to engage a bottom surface 115 of the rub rail 112 and an interior surface 119 of the rub rail 112 that defines a bottom opening of a stake pocket 116. The upper tension arm 2A and the lower tension arm 2A can engage with the rub rail 112 at the stake pocket 116. The upper tension arm 2A and the lower tension arm 2A can form a snap fit engagement with the rub rail 112 at the stake pocket 116. In some non-limiting examples, a length of the accessory 3 is substantially the same as a length of a linear section L of an exterior perimeter EP of the stake pocket 116. See, for example, a linear section L of an exterior pocket EP of a stake pocket 116 described above with reference to FIG. 6B. In one example embodiment, the length of the snap-on clip 2 is about 70 mm (2.756 inches). Advantageously, a snap-on clip 2 that is substantially the same length as the stake pocket 116 can be inhibited from moving lengthwise along the rub rail 112. In some examples, the snap-on clip 2 can include aluminum, a plastic, or a composite.

The snap-on clip 2 can include one or more prongs or posts 2B. The one or more prongs 2B can extend from a second side of the body portion 202 of the snap-on clip 2. The prong 2B can include barbed arms separated by a distance and configured to flex toward each other. The accessory 3 can include a plurality of grooves or channels 3A. The snap-on clip 2 can couple to the accessory 3. In this example, each of the prongs 2B of the snap-on clip 2 is configured to be received in a groove 3A of the accessory 3. Other types of engagement mechanisms can be suitably implemented in embodiments of the present disclosure. For example, the snap-on clip 2 can include a plurality of male tension snaps 2B configured to engage a plurality of female tension snaps 3A of the accessory 3.

The prongs 2B of the snap-on clip 2 can be configured to be received in the grooves 3A by a snapping engagement or a sliding engagement. For example, the barbed arms of the prong 2B can be configured to flex toward each other as the prong 2B is received in a groove 3A, and to flex away from each other after the prong 2B engages the groove 3A with a snap-fit. In such examples, the accessory 3 may engage a plurality of snap-on clips 2 simultaneously as described above with reference to systems 60 and 80.

The prong 2B can also be configured to slide into the groove 3A, starting from a front side or a rear side of the trailer 100, thereby engaging the snap-on clip 2 to the accessory 3 with a sliding engagement. In such cases, the barbed arms of the prong 2B may not flex or may flex minimally as the accessory 3 slides onto the snap-on clip 2. In such examples, the accessory 3 may slidingly engage a plurality of snap-on clips 2 sequentially as described above with reference to systems 60 and 80.

A length of an upper prong 2B can differ from a length of a lower prong 2B. A length of the lower prong 2B of the snap-on clip 2 can be greater than the length of the upper prong 2B. The length of the lower prong 2B can be optimized to allow the barbed arms to more readily flex toward each other as the prong 2B is received in a groove 3A.

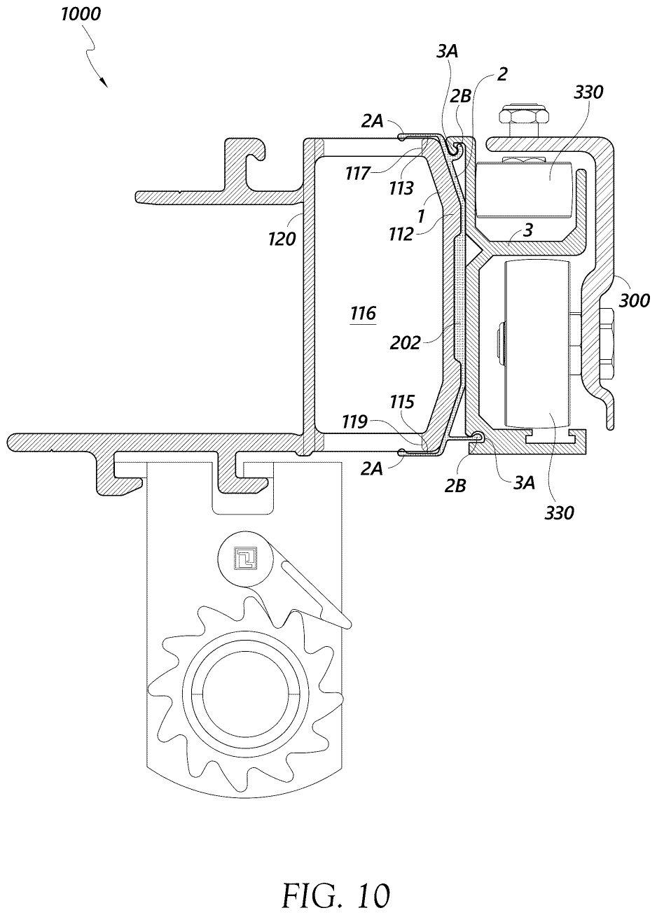

FIG. 10 illustrates a cross-sectional view of a system 1000 including a snap-on bracket 2 and an accessory 3 coupled to a rub rail 112 according to another embodiment of the present disclosure. In this non-limiting example, the accessory 3 includes a wheel track 3. The system 1000 can include a rub rail-side rail assembly 1, a snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail of the assembly 1, and can be configured to reversibly engage the accessory 3. The snap-on clip 2 can be configured to reversibly engage the rub rail of the assembly 1 via a snap-fit engagement, and can be configured to reversibly engage the accessory 3 via a snap-fit engagement. In this example, the accessory 3 includes a rolling tarp wheel track 3 configured to couple a rolling tarp to a trailer 100. The rub rail-side rail assembly 1 can be an extruded rub rail-side rail assembly 1, where the rub rail 112 and the side rail 120 are formed integrally as a monolithic structure. The snap-on clip 2 can include an upper tension arm 2A and a lower tension arm 2A similar to the snap-on clips 2 described above with reference to systems 60, 80, and 90. The upper tension arm 2A and the lower tension arm 2A can extend from a first side of a body portion 202 of the snap-on clip 2.

The snap-on clip 2 can include a hook or post 2B similar to a lower post 2B described above with reference to systems 60, 80, and 90. For example, the hook 2B can include barbed arms separated by a distance and configured to flex toward each other (not illustrated in FIG. 10). The hook 2B can extend from a second side of the body portion 202 of the snap-on clip 2. The accessory 3 can include a groove or channel 3A similar to a lower groove 3A described above with reference to systems 60, 80, and 90. The snap-on clip 2 can couple to the accessory 3. The hook 2B of the snap-on clip 2 can be configured to be received in the groove 3A of the accessory 3 by a snapping engagement or a sliding engagement, for example as described above with reference to systems 60, 80, and 90.

The snap-on clip 2 can include an upper hook or arm 2B. The upper hook 2B can extend from the second side of the body portion 202 of the snap-on clip 2. The accessory 3 can include an upper hook or arm 3A configured to engage the upper hook or arm 2B of the snap-on clip 2. The lower hook 2B can include a snap-fit barb 2B. The upper hook 2B of the snap-on clip 2 and the upper hook 3A of the accessory 3 can have different cross-sectional profiles. For example, the upper hook 2B of the snap-on clip 2 can include a substantially semi-circular profile and the upper hook 3A of the accessory 3 can include an arm terminating in a barb or bulb. The upper hook 3A of the accessory 3 can be configured to slide into the upper hook 2B of the snap-on clip 2, starting from a front side or a rear side of the trailer 100, thereby engaging the snap-on clip 2 to the accessory 3 with a sliding engagement.

The upper hook 2B of the snap-on clip 2 can be configured to engage the upper hook 3A of the accessory 3 with a sliding engagement at the same time the lower post 2B of the snap-on clip 2 engages the groove 3A of the accessory 3 with a sliding engagement. Alternatively, the upper hook 2B of the snap-on clip 2 can be configured to engage the upper hook 3A of the accessory 3 with a sliding engagement before the lower post 2B of the snap-on clip 2 engages the groove 3A of the accessory 3 with a snapping engagement. In one example method, the upper hook 3A of the accessory 3 is first engaged with the upper hook 2B of the snap-on clip 2 by a sliding engagement, while the groove 3A of the accessory 3 has not yet engaged the lower hook 2B of the snap-on clip 2. A bottom section of the accessory 3 is then pushed onto the snap-on clip 2, such that the hook 2B of the snap-on clip 2 snaps on to the groove 3A of the accessory 3.

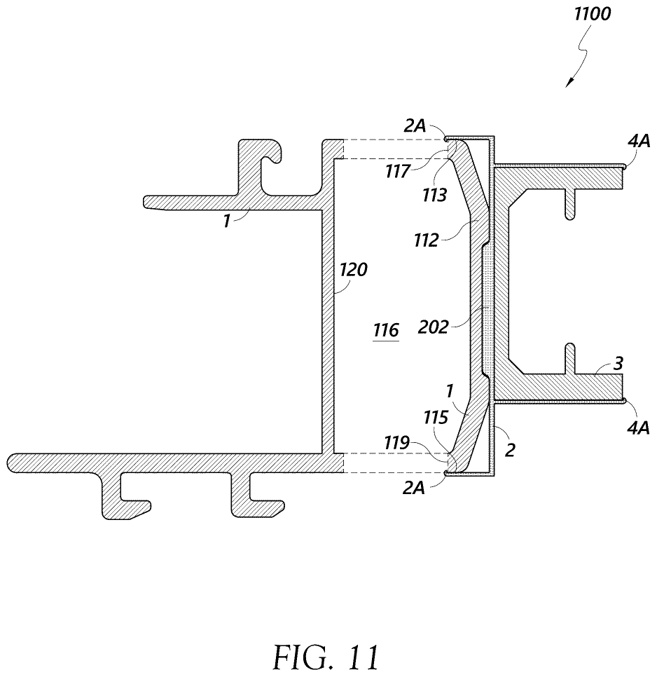

FIG. 11 illustrates a cross-sectional view of a system 1100 including a snap-on bracket 2 and an accessory 3 coupled to a rub rail 112 according to another embodiment of the present disclosure. In this non-limiting example, the accessory 3 includes a wheel track 3. The system 1100 can include a rub rail-side rail assembly 1, a snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail 112 of the assembly 1, and can be configured to reversibly engage the accessory 3. In this example, the accessory 3 includes a rolling tarp wheel track 3 configured to couple a rolling tarp to a trailer 100. The rub rail-side rail assembly 1 can be an extruded rub rail-side rail assembly 1, where the rub rail 112 and the side rail 120 are formed integrally as a monolithic structure.

The snap-on clip 2 can include an upper tension arm 2A and a lower tension arm 2A. The upper tension arm 2A and the lower tension arm 2A can extend from a first side of a body portion 202 of the snap-on clip 2. The snap-on clip 2 can couple to the rub rail 112 of the assembly 1 using tension forces caused by elastic bending of the upper tension arm 2A and the lower tension arm 2A of the snap-on clip 2. The upper tension arm 2A can include an arm terminating in a barb or bulb. The upper tension arm 2A can be configured to engage a top surface 113 of the rub rail 112 and an interior surface 117 of the rub rail 112 that defines a top opening of a stake pocket 116. The lower tension arm 2A can include an arm terminating in a barb or bulb. The lower tension arm 2A can be configured to engage a bottom surface 115 of the rub rail 112 and an interior surface 119 of the rub rail 112 that defines a bottom opening of a stake pocket 116. The upper tension arm 2A and the lower tension arm 2A can engage with the rub rail 112 at the stake pocket 116. The upper tension arm 2A and the lower tension arm 2A can form a snap fit engagement with the rub rail 112 at the stake pocket 116. In some non-limiting examples, a length of the accessory 3 is substantially the same as a length of a linear section L of an exterior perimeter EP of the stake pocket 116. See, for example, a linear section L of an exterior pocket EP of a stake pocket 116 described above with reference to FIG. 6B. In one example embodiment, the length of the snap-on clip 2 is about 70 mm (2.756 inches). Advantageously, a snap-on clip 2 that is substantially the same length as the stake pocket 116 can be inhibited from moving lengthwise along the rub rail 112. In some examples, the snap-on clip 2 can include aluminum, a plastic, or a composite.

The snap-on clip 2 can include a second set of tension arms, for example upper tension arm 4A and lower tension arm 4A. The upper tension arm 4A and the lower tension arm 4A can extend from a second side of the body portion 202 of the snap-on clip 2. The snap-on clip 2 can couple to the accessory 3 using tension forces caused by elastic bending of the upper tension arm 4A and the lower tension arm 4A of the snap-on clip 2. The upper tension arm 4A can include an arm terminating in a barb or bulb. The upper tension arm 4A can be configured to engage a top surface of the accessory 3 and an exterior surface of the accessory 3. The lower tension arm 4A can include an arm terminating in a barb or bulb. The lower tension arm 4A can be configured to engage a bottom surface of the accessory 3 and an exterior surface of the accessory 3. The upper tension arm 4A and the lower tension arm 4A can form a snap fit engagement with the rub rail 112 at the stake pocket 116.

The upper tension arm 4A and the lower tension arm 4A of the snap-on clip 2 can be configured to engage the accessory 3 by a snapping engagement or a sliding engagement. For example, the accessory 3 may engage a plurality of snap-on clips 2 simultaneously as the accessory 3 is first aligned against the side of the trailer and then pushed laterally into a snap-lock engagement with the snap-on clips 2. For example, the accessory 3 may engage a first snap-on clip 2 coupled to the rub rail 112 at a first stake pocket 116 at the same time or nearly the same time the accessory 3 engages a second, adjacent snap-on clip 2 coupled to the rub rail 112 at a second, adjacent stake pocket 116.

The accessory 3 can also be configured to slide into a space between the upper tension arm 4A and the lower tension arm 4A, starting from a front side or a rear side of the trailer 100, thereby engaging the snap-on clip 2 to the accessory 3 with a sliding engagement. In such examples, the accessory 3 may slidingly engage a plurality of snap-on clips 2 sequentially as the accessory 3 is slid along the trailer 100 from a front section toward a rear section of the trailer 100, or from the rear section toward the front section of the trailer 100. For example, the accessory 3 may first slidingly engage a first snap-on clip 2 coupled to the rub rail 112 at a first stake pocket 116, and then slidingly engage a second, adjacent snap-on clip 2 coupled to the rub rail 112 at a second, adjacent stake pocket 116.

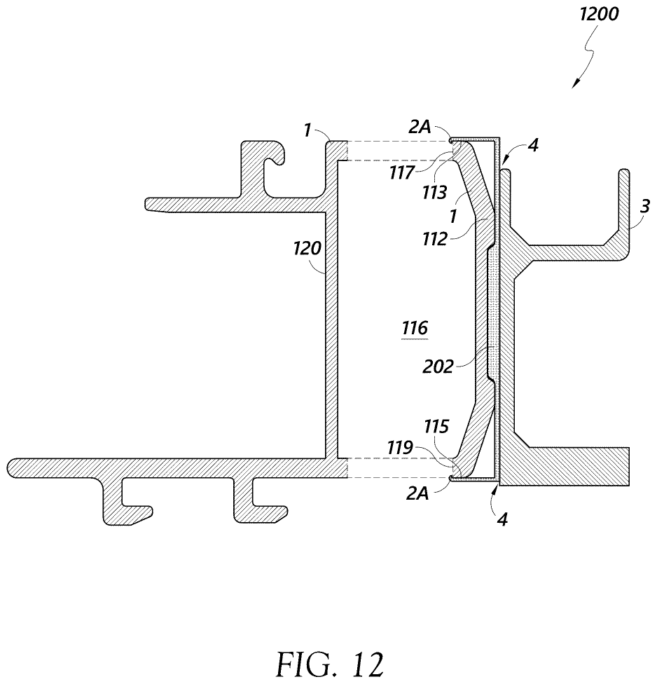

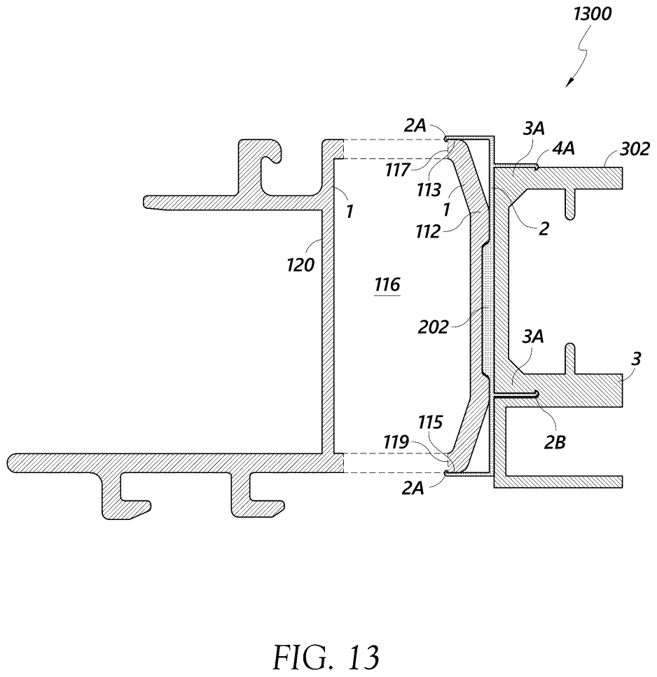

FIG. 12 illustrates a cross-sectional view of a system 1200 including an accessory 3 coupled to a rub rail according to another embodiment of the present disclosure. In this non-limiting embodiment, the accessory 3 includes a wheel track 3. The system 1200 can include a rub rail-side rail assembly 1 and the accessory 3. The accessory 3 can include a plurality of snap-on clips or brackets 2 configured to couple to the rub rail-side rail assembly 1. The snap-on clips 2 can be configured to reversibly engage the rub rail 112 of the assembly 1. In this example, the accessory 3 includes a rolling tarp wheel track 3 configured to couple a rolling tarp to a flatbed trailer. The rub rail-side rail assembly 1 can be an extruded rub rail-side rail assembly 1, where the rub rail 112 and the side rail 120 are formed integrally as a monolithic structure.

The wheel track 3 can be coupled to one or more snap-on clips 2 by welding an interior surface of the wheel track 3 to an exterior surface of each of a plurality of snap-on clips 2 formed of a suitable material, such as aluminum. The wheel track 3 can couple to a snap-on clip 2 via a weld 4 at an upper point of the wheel track 3. The wheel track 3 can couple to a snap-on clip 2 via a weld 4 at a lower point of the wheel track 3. The wheel track 3 can be welded to the snap-on clip 2 where the edges of the wheel track 3 contact the snap-on clip 2. In implementations in which a snap-on clip 2 is engaged to the rub rail 112 of the assembly 1 at every stake pocket of the rub rail 112, a snap-on clip 2 can be welded to the wheel track 3 at 4 foot intervals. Other methods for coupling the wheel track 3 to the plurality of snap-on clips 2 can be suitably implemented. For example, in implementations where the snap-on clip 2 includes plastic or a composite and the wheel track 3 includes aluminum, the snap-on clip 2 can be fastened to the wheel track 3 using bolts or other fasteners.

To install the wheel track 3 on the rub rail-side rail assembly 1, the wheel track 3 can first be aligned against the side of the trailer 100 and then pushed laterally such that each snap-on click 2 engages a portion of the rim of the rub rail 112 at a corresponding stake pocket 116. Each snap-on click 2 can engage a portion of the rim of the rub rail 112 at a corresponding stake pocket 116 via an upper tension arm 2A and a lower tension arm 2A with a snap-lock engagement. The upper tension arm 2A and the lower tension arm 2A can extend from a first side of a body portion 202 of the snap-on clip 2. For example, the accessory 3 may engage a first stake pocket 116 of the rub rail 112 at the same time or nearly the same time the accessory 3 engages a second, adjacent stake pocket 116 of the rub rail 112. In some non-limiting examples, a length of the accessory 3 is substantially the same as a length of a linear section L of an exterior perimeter EP of the stake pocket 116. See, for example, a linear section L of an exterior pocket EP of a stake pocket 116 described above with reference to FIG. 6B. In one example embodiment, the length of the accessory 3 is about 70 mm (2.756 inches). Advantageously, an accessory 3 that is substantially the same length as the stake pocket 116 can be inhibited from moving lengthwise along the rub rail 112.

FIG. 13 illustrates a cross-sectional view of a system 1300 including a snap-on bracket 2 and an accessory 3 coupled to a rub rail 112 according to another embodiment of the present disclosure. In this non-limiting example, the accessory 3 includes a wheel track 3. The system 1300 can include a rub rail-side rail assembly 1, a snap-on bracket 2, and the accessory 3. The snap-on bracket 2 can include a snap-on clip 2 configured to couple to the rub rail-side rail assembly 1 and also configured to couple to the accessory 3. The snap-on clip 2 can be configured to reversibly engage the rub rail 112 of the assembly 1, and can be configured to reversibly engage the accessory 3. In this example, the accessory 3 includes a rolling tarp wheel track 3 configured to couple a rolling tarp to a trailer 100. The rub rail-side rail assembly 1 can be an extruded rub rail-side rail assembly 1, where the rub rail 112 and the side rail 120 are formed integrally as a monolithic structure.

The snap-on clip 2 can include an upper tension arm 2A and a lower tension arm 2A. The upper tension arm 2A and the lower tension arm 2A can extend from a first side of a body portion 202 of the snap-on clip 2. The snap-on clip 2 can couple to the rub rail 112 of the assembly 1 using tension forces caused by elastic bending of the upper tension arm 2A and the lower tension arm 2A of the snap-on clip 2. The upper tension arm 2A can include an arm terminating in a barb or bulb. The upper tension arm 2A can be configured to engage a top surface 113 of the rub rail 112 and an interior surface 117 of the rub rail 112 that defines a top opening of a stake pocket 116. The lower tension arm 2A can include an arm terminating in a barb or bulb. The lower tension arm 2A can be configured to engage a bottom surface 115 of the rub rail 112 and an interior surface 119 of the rub rail 112 that defines a bottom opening of a stake pocket 116. The upper tension arm 2A and the lower tension arm 2A can engage with the rub rail 112 at the stake pocket 116. The upper tension arm 2A and the lower tension arm 2A can form a snap fit engagement with the rub rail 112 at the stake pocket 116. In some non-limiting examples, a length of the accessory 3 is substantially the same as a length of a linear section L of an exterior perimeter EP of the stake pocket 116. See, for example, a linear section L of an exterior pocket EP of a stake pocket 116 described above with reference to FIG. 6B. In one example embodiment, the length of the accessory 3 is about 70 mm (2.756 inches). Advantageously, an accessory 3 that is substantially the same length as the stake pocket 116 can be inhibited from moving lengthwise along the rub rail 112. In some examples, the snap-on clip 2 can include aluminum, a plastic, or a composite.

The snap-on clip 2 can include a third tension arm, for example an upper tension arm 4A. The upper tension arm 4A can extend from a second side of a body portion 202 of the snap-on clip 2. The snap-on clip 2 can couple to the accessory 3 using tension forces caused by elastic bending of the upper tension arm 4A of the snap-on clip 2. The upper tension arm 4A can include an arm terminating in a barb or bulb. The upper tension arm 4A can be configured to engage a top surface 302 of the accessory 3. The upper tension arm 4A of the snap-on clip 2 can be configured to engage the top surface 302 of the accessory 3 by a snapping engagement or a sliding engagement, for example as described above with reference to system 1100.

The snap-on clip 2 can include a prong or post 2B similar to a lower post 2B described above with reference to systems 60, 80, and 90. The prong or post 2B can extend from the second side of the body portion 202 of the snap-on clip 2 For example, the prong 2B can include barbed arms separated by a distance and configured to flex toward each other. The accessory 3 can include a groove or channel 3A similar to a lower groove 3A described above with reference to systems 60, 80, and 90. The snap-on clip 2 can couple to the accessory 3. The prong 2B of the snap-on clip 2 can be configured to be received in the groove 3A of the accessory 3 by a snapping engagement or a sliding engagement, for example as described above with reference to systems 60, 80, and 90.

In implementations in which the upper tension arm 4A engages the top surface 302 of the accessory 3 and the prong 2B engages the groove 3A with a snapping engagement, the accessory 3 may engage a plurality of snap-on clips 2 simultaneously as the accessory 3 is first aligned against the side of the trailer and then pushed laterally into a snap-lock engagement with the upper tension arms 4A and the prongs 2B of the snap-on clips 2. For example, the accessory 3 may engage a first snap-on clip 2 coupled to the rub rail 112 at a first stake pocket 116 at the same time or nearly the same time the accessory 3 engages a second, adjacent snap-on clip 2 coupled to the rub rail 112 at a second, adjacent stake pocket 116.

In implementations in which the upper tension arm 4A engages the top surface 302 of the accessory 3 with a sliding engagement and the prong 2B engages the groove 3A with a sliding engagement, the accessory 3 may slidingly engage a plurality of snap-on clips 2 sequentially as the accessory 3 is slid along the trailer 100 from a front section toward a rear section of the trailer, or from the rear section toward the front section of the trailer 100. For example, the accessory 3 may first slidingly engage a first snap-on clip 2 coupled to the rub rail 112 at a first stake pocket 116, and then slidingly engage a second, adjacent snap-on clip 2 coupled to the rub rail 112 at a second, adjacent stake pocket 116.

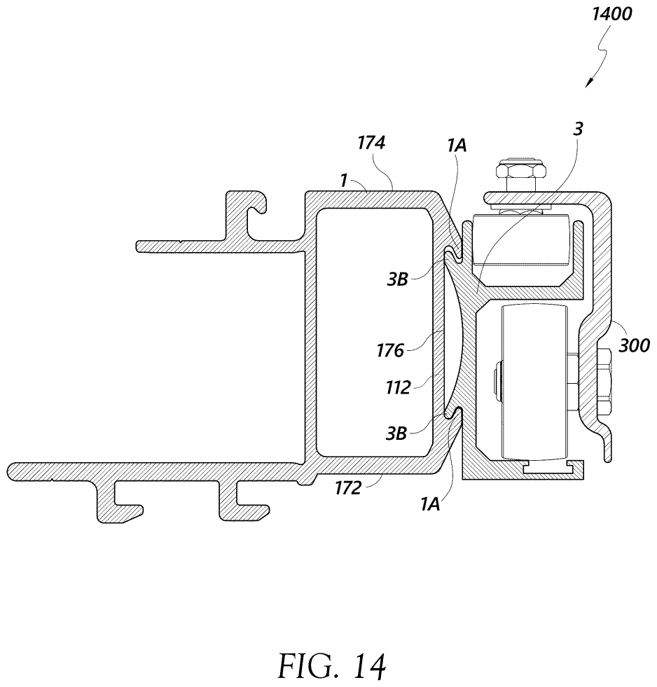

FIG. 14 illustrates a cross-sectional view of a system 1400 including an accessory 3 coupled to a rub rail 112 according to another embodiment of the present disclosure. In this non-limiting example, the accessory 3 includes a slide-on wheel track 3. The system 1400 can include a rub rail-side rail assembly 1 and the accessory 3. The accessory 3 can include a plurality of tongues or arms 3B. Each tongue 3B can be configured to couple to a groove formed between a pair of tongues 1A in the rub rail 112. Thus, the accessory 3 can be configured to couple to the rub rail 112 using a tongue-and-groove engagement. The accessory 3 can be configured to reversibly engage the rub rail 112 of the assembly 1. In this example, the accessory 3 includes a rolling tarp wheel track 3 configured to couple a rolling tarp 300 to a trailer 100. The rub rail-side rail assembly 1 can be an extruded rub rail-side rail assembly 1, where the rub rail 112 and the side rail 120 are formed integrally as a monolithic structure.

The rub rail 112 can include a top surface 174 and a bottom surface 172. The rub rail 112 can also include an external side surface 176 between the upper tongue 1A and the lower tongue 1A. The upper tongue 1A and lower tongue 1A can extend along the length of the external side surface 176 parallel to one another such that the upper and lower tongues 1A can slidably engage the accessory 3. A groove can be formed between the upper tongue 1A, the external side surface 176, and the lower tongue 1A.

The tongues 3B of the accessory 3 can be configured to be received in the tongues 1B of the rub rail 112 by a sliding engagement, for example as described above with reference to systems 60, 80, and 90. For example, the accessory 3 may slidingly engage the rub rail 112 as the accessory 3 is slid along the trailer 100 from a front section toward a rear section of the trailer 100, or from the rear section toward the front section of the trailer 100.

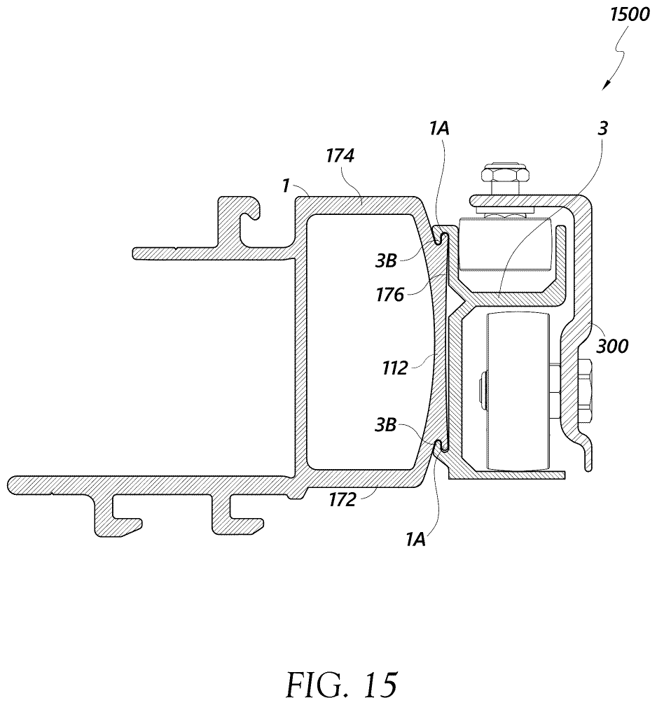

FIG. 15 illustrates a cross-sectional view of a system 1500 including an accessory 3 coupled to a rub rail 112 according to another embodiment of the present disclosure. In this non-limiting example, the accessory 3 includes a slide-on wheel track 3. The system 1500 can include a rub rail-side rail assembly 1 and the accessory 3. The accessory 3 can include a plurality of grooves or channels 3B. Each groove 3B can be configured to couple to a tongue 1A of the rub rail 112 of the rub rail-side rail assembly 1. Thus, the accessory 3 can be configured to couple to the rub rail 112 using a tongue-and-groove engagement. The accessory 3 can be configured to reversibly engage the rub rail 112 of the assembly 1. In this example, the accessory 3 includes a rolling tarp wheel track 3 configured to couple a rolling tarp 300 to a trailer 100. The rub rail-side rail assembly 1 can be an extruded rub rail-side rail assembly 1, where the rub rail 112 and the side rail 120 are formed integrally as a monolithic structure.

The rub rail 112 can include a top surface 174 and a bottom surface 172. The rub rail 112 can also include an external side surface 176 between the upper tongue 1A and the lower tongue 1A. The upper tongue 1A and lower tongue 1A can extend along the length of the external side surface 176 parallel to one another such that the upper and lower tongues 1A can slidably engage the accessory 3.

The tongues 1A of the rub rail 112 can be configured to be received in the grooves 3B of the accessory 3 by a sliding engagement, for example as described above with reference to systems 60, 80, and 90. For example, the accessory 3 may slidingly engage the rub rail 112 as the accessory 3 is slid along the trailer 100 from a front section toward a rear section of the trailer 100, or from the rear section toward the front section of the trailer 100.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

What is claimed is:

1. A snap-on accessory mount for trailer rub rails, the snap-on accessory mount comprising:
a body portion;
an upper tension arm and a lower tension arm extending from a first side of the body portion, the upper tension arm and the lower tension arm configured to couple to a rub rail of a trailer; and
a plurality of prongs configured to couple to an accessory.

2. The snap-on accessory mount of claim 1, wherein the upper tension arm and the lower tension arm are parallel.

3. The snap-on accessory mount of claim 1, wherein the upper tension arm comprises a barbed arm configured to engage a top surface of the rub rail; and wherein the lower tension arm comprises a barbed arm configured to engage a bottom surface of the rub rail.

4. The snap-on accessory mount of claim 1, wherein the plurality of prongs extend from a second side of the body portion opposite the first side of the body portion.

5. The snap-on accessory mount of claim 1, wherein a length of the body portion is the same as a length of a linear section of an exterior perimeter of a stake pocket of the trailer rub rail.

6. The snap-on accessory mount of claim 1, wherein a length of the body portion is 70 mm.

7. The snap-on accessory mount of claim 1, wherein the body portion is configured to contact a portion of an external surface of the rub rail.

8. The snap-on accessory mount of claim 1, wherein the snap-on accessory mount comprises aluminum.

9. The snap-on accessory mount of claim 1, wherein the snap-on accessory mount comprises plastic.

10. The snap-on accessory mount of claim 1, wherein a prong of the plurality of prongs comprises an arm configured to engage a groove of the accessory with a snap-fit engagement.

11. The snap-on accessory mount of claim 1, wherein a prong of the plurality of prongs comprises a barbed arm configured to flex as the prong is received in a groove of the accessory.

12. The snap-on accessory mount of claim 1, wherein each of the plurality of prongs is configured to slidingly engage a groove of the accessory.

13. The snap-on accessory mount of claim 1, wherein the accessory comprises a rolling tarp wheel track.

14. A system for mounting an accessory on a rub rail of a trailer, the system comprising:
the accessory comprising a plurality of grooves; and
a snap-on accessory mount comprising:
a body portion;
an upper tension arm and a lower tension arm extending from a first side of the body portion, the upper tension arm and the lower tension arm configured to couple to the rub rail of the trailer; and
a plurality of prongs, each of the plurality of prongs configured to engage one of the plurality of grooves of the accessory.

15. The system of claim 14, wherein a prong of the plurality of prongs comprises an arm configured to engage one of the plurality of grooves of the accessory with a snap-fit engagement.

16. The system of claim 14, wherein a prong of the plurality of prongs comprises a barbed arm configured to flex as the prong is received in one of the plurality of grooves of the accessory.

17. The system of claim 14, wherein each of the plurality of prongs is configured to slidingly engage one of the plurality of grooves of the accessory.

18. The system of claim 14, wherein the accessory comprises a rolling tarp wheel track.

19. The system of claim 14, further comprising a second snap-on accessory mount comprising:
a body portion;
an upper tension arm and a lower tension arm extending from a first side of the body portion, the upper tension arm and the lower tension arm configured to couple to the rub rail of the trailer; and
a plurality of prongs configured to engage the accessory.

20. The system of claim 19, wherein the snap-on accessory mount and the second snap-on accessory mount are configured to engage with the accessory at different locations along a length of the accessory.

21. The system of claim 19, wherein the snap-on accessory and the second snap-on accessory are configured to sequentially engage with the accessory.

22. The system of claim 19, wherein the snap-on accessory and the second snap-on accessory are configured to simultaneously engage with the accessory.

23. The system of claim 14, wherein the rub rail is integral to a side rail of the trailer.

24. The system of claim 14, wherein the rub rail is welded to a side rail of the trailer.
